(19) United States
(12) Patent Application Publication
(10) Pub. No.: US 2014/0097752 A1
(43) Pub. Date: Apr. 10, 2014

(54) Inductively Coupled Plasma ION Source Chamber with Dopant Material Shield

(71) Applicant: VARIAN SEMICONDUCTOR EQUIPMENT ASSOCIATES, INC., Gloucester, MA (US)

(72) Inventors: Costel Biloui, Rockport, MA (US); Timonthy J. Miller, Ipswich, MA (US); Bon-Woong Koo, Andover, MA (US); Anthony Renau, West Newbury, MA (US)

(73) Assignee: VARIAN SEMICONDUCTOR EQUIPMENT ASSOCIATES, INC., Gloucester, MA (US)

(21) Appl. No.: 13/647,540

(22) Filed: Oct. 9, 2012

(51) Int. Cl. H01J 27/16

(52) U.S. Cl. 315/111.81

(57) ABSTRACT

A plasma ion source including a plasma chamber, gas inlets, an RF antenna, an RF window, an extraction plate, a window shield, and a chamber liner. The RF window may be positioned intermediate the RF antenna and the plasma chamber. The window shield may be disposed intermediate the RF widow and the interior of the plasma chamber and the chamber liner may cover the interior surface of the plasma chamber. During operation of the ion source, the window shield sustains ionic bombardment that would otherwise be sustained by the RF window. Fewer impurity ions are therefore released into the plasma chamber. Simultaneously, additional dopant atoms are released from the window shield into the plasma chamber. Ionic bombardment is also sustained by the chamber liner, which also contributes a quantity of dopant atoms to the plasma chamber. Dopant ion production within the plasma chamber is thereby increased while impurities are minimized.

### FIELD OF THE DISCLOSURE

The disclosure relates generally to the field of semiconductor device fabrication, and more particularly to an ion source having a shield formed of dopant material disposed adjacent an RF window for reducing an amount of atomic impurities released by the RF window and increasing atomic dopant production.

### BACKGROUND OF THE DISCLOSURE

Ion implantation is a process used to dope ions into a work piece or target substrate. For example, ion implantation may be used to implant III-group or V-group impurity ions during the manufacture of semiconductor substrates to obtain desired electrical device characteristics. An ion implanter generally includes an ion source chamber which generates ions of a particular species, a series of beam line components configured to shape, analyze, and drive an ion beam extracted from the source chamber, and a platen for holding the target substrate into which the ion beam is steered. These components are housed in a vacuum environment to prevent dispersion of the ion beam during its travel from the source to the target.

The beam line components of an ion implanter may include a series of electrodes configured to extract ions from the source chamber, a mass analyzer configured with a particular magnetic field such that only ions having a desired mass-to-charge ratio are allowed to pass through the analyzer, and a corrector magnet configured to provide a ribbon beam which is directed to the platen almost orthogonally with respect to the ion beam to implant the ions into a target substrate. The ions lose energy when they collide with nuclei and electrons in the substrate and come to rest at a desired depth within the substrate based on the acceleration energy. The depth of implantation into the substrate is a function of ion energy and the mass of the ions generated in the source chamber. Typically, arsenic or phosphorus may be doped to form n-type regions in a substrate, and boron, gallium, or indium may be doped to create p-type regions in a substrate.

The most common p-type semiconductor dopant is boron. In plasma sources, elemental boron ions are obtained by introducing a boron-containing feed gas, such as BF₃ or BF₃/B₂H₆/H₂, into an ion source chamber. The feed gas molecules are dissociated and the boron atoms are ionized through induced electron collisions within the source chamber. Because the feed gas molecules are not fully dissociated, a plasma source may produce a wide variety of ionic species (B⁺, F⁺, BF⁺, BF₂⁺, BF₃⁺, B₂F₄⁺, etc.). Thus, only a small fraction (e.g.15-20%) of the total ion beam emanating from the source chamber may consist of positively charged, elemental boron ions (B⁺).

Various types of ion sources may be employed for ionizing feed gases. Such sources are typically selected based on the type of plasma desired as well as an associated ion beam profile for implantation into a target substrate. One type of ion source is a hot-cathode ion source that utilizes an indirectly heated cathode (IHC) to ionize a feed gas in a source chamber. Another type of ion source is an inductively-coupled, RF (radio frequency) plasma ion source which utilizes an RF coil to excite, through electromagnetic induction, a feed gas in a source chamber. A dielectric RF window separates the interior of the source chamber from the RF coil. The power delivered to the RF coil can be adjusted to control the density of the plasma and the extracted ion beam current.

A problem that is commonly associated with RF plasma sources is that, even when operating in an inductively-coupled mode, a slight capacitive coupling may still exist and cause a quantity of plasma ions to be accelerated toward, and to bombard, the RF window. Such bombardment etches the RF window and causes a substantial quantity of undesirable atomic species to be sputtered from the window into the source chamber. For example, FIG. 1 illustrates the mass spectra of a BF₃ plasma produced in an inductively-coupled ion source having a quartz (SiO₂) RF window. As can be seen, a significant quantity of silicon was sputtered or etched from the window resulting in a large quantity of impurity ions (e.g., Si⁺, SiF⁺, SiF₂⁺, etc.) in the plasma. In the case of non-analyzed beams these impurities may subsequently be implanted into a target substrate along with desired dopant ion species such as positively charged boron ions.

It is therefore desirable to provide an ion source chamber that contributes fewer impurities to an ion beam emanating therefrom. It is further desirable to provide such an ion source chamber that increases the quantity of desired dopant ions in an ion beam emanating therefrom.

### SUMMARY

In view of the foregoing, an ion source is disclosed for providing a simple, cost effective means by which a quantity of impurity ions in an ion beam can be minimized without the use of mass spectrometers and other complex, expensive beam line components. Moreover, the ion source of the present disclosure simultaneously increases the quantity of desired dopant ions in an ion beam.

The ion source of the present disclosure may include a plasma chamber, an RF antenna, an RF window, a RF window shield made of dopant material, and a plasma chamber liner made of dopant material. The plasma chamber may be a generally rectangular or cylindrical enclosure provided for holding a feed gas as further described below. The RF window may have a substantially planar shape and may be mounted to, and may substantially vacuum seal, the top end of the plasma chamber. The RF antenna is located atop the RF window, on the opposite side of the window relative to the plasma chamber. The RF window is thus the medium through which RF power from the RF generator is transferred from the RF antenna to the low pressure feed gas inside the plasma chamber. The RF window may be formed of any suitable dielectric material, such as alumina, sapphire, or quartz, which is capable of facilitating such coupling.

The window shield and the chamber liner may be formed of thin layers of a desired dopant material. The window shield may be disposed intermediate the RF widow and the interior of the plasma chamber. The chamber liner may be disposed within the plasma chamber, immediately adjacent to and covering the interior surface of the plasma chamber.

During normal operation of the ion source, plasma is created in the plasma chamber through inductive coupling in a conventional manner. However, the window shield undergoes heavy ionic bombardment that would otherwise be sustained by the RF window. Fewer impurity ions are therefore released from the RF window into the plasma chamber. Simultaneously, the ionic bombardment and the etching effect of the plasma on the window shield made of dopant material causes additional dopant atoms to be released from the shield into the plasma chamber. Ionic bombardment and plasma etching can also occur at the surface of the chamber liner made of dopant material, which contributes an additional quantity of dopant atoms to the plasma. Dopant ion production within the plasma chamber is thereby increased and a more dopant-rich ion beam is produced.

In an exemplary embodiment of the present disclosure, an ion source may include an RF window, a plasma chamber disposed on a first side of the RF window, an RF antenna disposed on a second side of the RF window opposite the first side, and a window shield formed of a dopant material disposed intermediate the first side of the RF window and the plasma chamber. The ion source may further include a chamber liner formed of a dopant material disposed adjacent an interior surface of a sidewall of the plasma chamber.

### BRIEF DESCRIPTION OF THE DRAWINGS

FIG. 1 is a graph illustrating the mass spectra of a BF₃ plasma produced in an inductively coupled ion source having a quartz (SiO₂) RF window

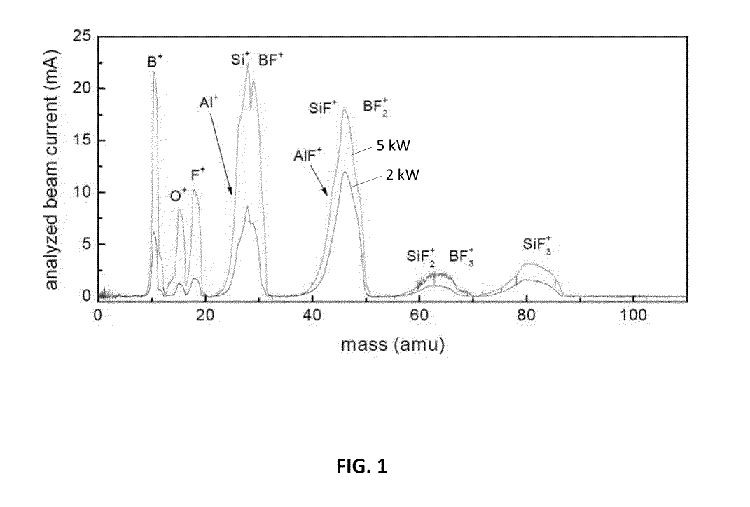

FIG. 2 is a side view in section illustrating an RF ion source in accordance with the present disclosure.

FIG. 3 is a bottom view in section illustrating the ion source in accordance with the present disclosure.

FIG. 4. Is a graph illustrating the sputtering yield from a window shield formed of boron when bombarded with boron and argon ions.

### DETAILED DESCRIPTION

A device in accordance with the present disclosure will now be described more fully hereinafter with reference to the accompanying drawings, in which preferred embodiments of the device are shown. This device, however, may be embodied in many different forms and should not be construed as being limited to the embodiments set forth herein. Rather, these embodiments are provided so that this disclosure will be thorough and complete, and will fully convey the scope of the device to those skilled in the art. In the drawings, like numbers refer to like elements throughout.

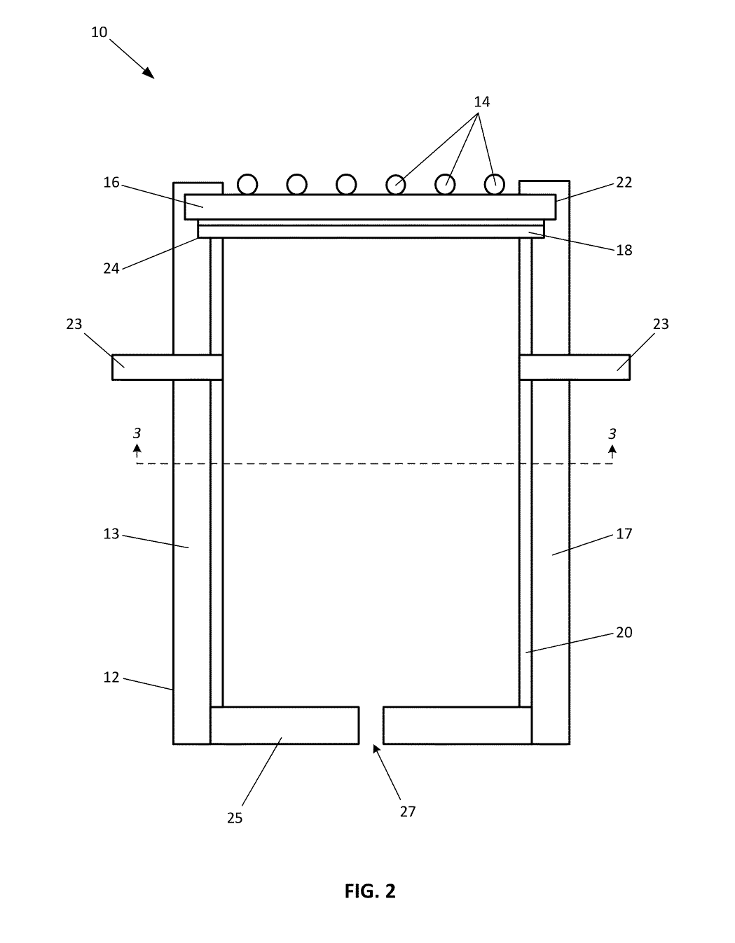

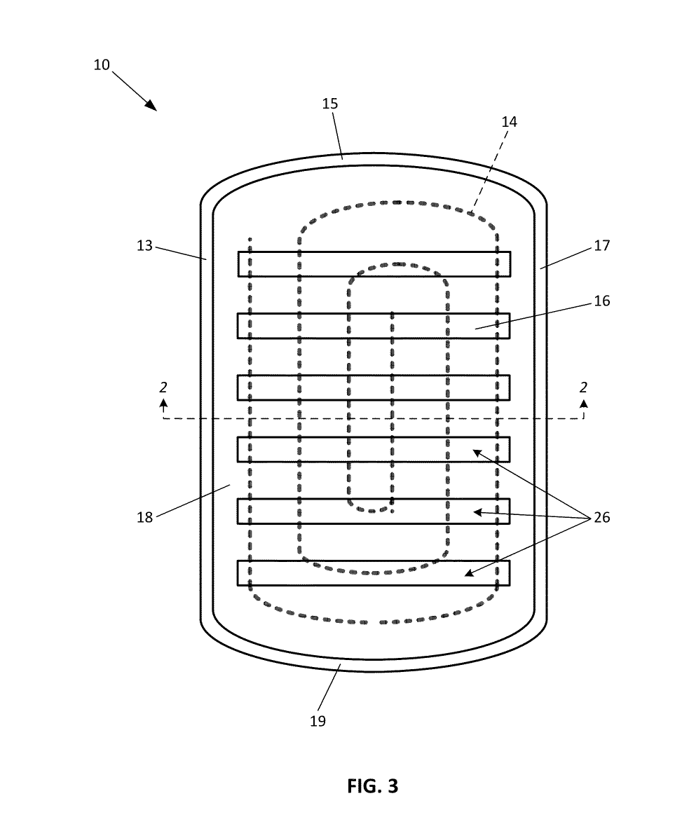

Referring to FIGS. 2 and 3, an embodiment of a plasma ion source 10 (hereinafter referred to as “the RF ion source 10”) in accordance with the present disclosure is shown. The RF ion source 10 may include a plasma chamber 12, an RF antenna 14, an RF window 16, a window shield 18, a chamber liner 20, one or more gas inlets 23, and a face plate 25 having an extraction slit 27 through which the ions are extracted. For the sake of convenience and clarity, terms such as “front,” “rear,” “top,” “bottom,” “up,” “down,” “inwardly,” “outwardly,” “lateral,” and “longitudinal” will be used herein to describe the relative placement and orientation of components of the RF ion source 10, each with respect to the geometry and orientation of the RF ion source 10 as it appears in FIG. 2. Said terminology will include the words specifically mentioned, derivatives thereof, and words of similar import.

The plasma chamber 12 may be a rectangular, cylindrical or more complex enclosure provided for holding a feed gas at low pressure as further described below. The plasma chamber 12 may be defined by vertically-extending sidewalls 13, 15, 17, and 19. The sidewalls 13-19 may be formed of aluminum, stainless steel, or a dielectric such as alumina or quartz.

The RF window 16 may be a substantially planar member having a shape that is substantially similar to the cross sectional shape of the plasma chamber 12. The RF window 16 may be mounted to, and may substantially vacuum seal, the top end of the plasma chamber 12. For example, the edges of the RF window 16 may be seated within a recess 22 formed in the interior surfaces of the sidewalls 13-19 as shown in FIG. 2. Alternatively, it is contemplated that the RF window 16 may be fastened to the top edges of the sidewalls 13-19, such as with adhesives or mechanical fasteners. It is further contemplated that a high temperature O-ring or other suitable sealing member may be disposed intermediate the edges of the RF window 16 and the sidewalls 13-19 for establishing a vacuum seal therebetween. The RF window 16 may thus be disposed in a substantially horizontal orientation vertically intermediate the interior of the plasma chamber 12 and the RF antenna 14 (described below).

The RF window 16 is the medium through which RF energy from the RF antenna 14 is coupled to the feed gas inside the plasma chamber 12, as further described below. The RF window 16 may be formed of any conventional material, including, but not limited to, alumina, sapphire, or quartz, that is capable of facilitating such coupling. Although alumina and quartz provide desirable properties for certain applications, they have relatively low thermal conductivity and may be prone to vacuum seal failures with the sidewalls 13-19 of the plasma chamber 12 at high operating temperatures. Alternatively, aluminum-nitride (AlN) may provide relatively higher thermal conductivity while having a similar dielectric constant to quartz or alumina. AlN can be employed in high processing temperature applications and has high electrical resistivity comparable to typical ceramic materials. In addition, AN can be metalized and brazed to the metal sidewalls 13-19 of the plasma chamber 12 to provide a robust vacuum seal therebetween. This obviates the need for O-ring seals which may degrade over time.

The window shield 18 and chamber liner 20 may be formed of thin layers of a desired dopant material that may be the same as the dopant in the feed gas supplied to the plasma chamber 12 (as further described below). For example, if the desired dopant for a particular application is boron, the feed gas supplied to the plasma chamber 12 may contain boron (e.g., BF₃, B₂F₄, or B₂H₆) and the window shield 18 and chamber liner 20 may be formed of thin sheets of boron. For example, since only ¹¹B isotope is of interest for semiconductor applications, the sheets may be made of isotopically separated boron from which ¹⁰B isotope was removed. Other possible dopant materials include, but are not limited to, arsenic, phosphorus, aluminum, indium, antimony, and various alloys and compounds that contain such elements. Thus, the particular material from which the window shield and chamber liner are formed will generally depend on the desired dopant ionic specie in the RF ion source 10. It is contemplated that the window shield 18 and chamber liner 20, and particularly the window shield 18, may be sinterized to provide enhanced dielectric properties for allowing substantially unhindered RF power transmission therethrough (i.e., from the RF antenna 14 into the plasma chamber 12). The shield 18 and the liner 20 may each have a thickness in a range of about 1 millimeter to about 5 millimeters, but this is not critical. It is contemplated that either the shield 18 or the liner 20 may be made thinner or thicker without departing from the present disclosure. It is further contemplated that, instead of being formed as separate members, the shield 18 and the liner 20 can alternatively be formed as a single, contiguous body.

The window shield 18 may be disposed below the RF window 16 in a parallel relationship therewith, intermediate the RF widow and the interior of the plasma chamber 12. For example, the window shield 18 may be seated atop an upwardly-facing surface of a shoulder 24 formed in the interior surfaces of the sidewalls 13-19 of the plasma chamber 12. The window shield 18 may be spaced apart from the RF window 16 by a vertical distance of 0 to 5 millimeters. It is contemplated that the window shield 18 may flatly abut, and may be adhered or directly fastened to, the bottom surface of the RF window 16. The window shield 18 may cover substantially the entire bottom surface of the RF window 16 that is exposed to the interior of the plasma chamber 12 except for a series of slots 26 formed through the shield 18 (further described below).

The chamber liner 20 may be formed of a sheet of dopant material (described above) that is rolled and/or folded or sintered to produce a sleeve having a cross sectional size and shape that are substantially the same as the cross sectional size and shape of the interior surface of the plasma chamber 12. The liner 20 may thus be disposed within the plasma chamber 12, immediately adjacent to and covering substantially the entire interior surface of the plasma chamber 12, and may be fastened to the interior surface of the plasma chamber 12 with adhesives or mechanical fasteners. Alternatively, it is contemplated that the chamber liner 20 may cover less than substantially the entire interior surface of the plasma chamber 12. It is further contemplated that the chamber liner 20 may be entirely omitted from the RF ion source 10.

The RF antenna 14 may be disposed above the RF window 16 for providing effective RF energy coupling to the feed gas inside the plasma chamber 12. The RF antenna 14 may be of a flat spiral variety that will be familiar to those of ordinary skill in the art. However, it will be appreciated that the particular shape, size, and configuration of the RF antenna 14 may be varied without departing from the present disclosure. As a feed gas is supplied to the interior of the plasma chamber 12 via inlet ports 23, the RF antenna 14 supplies RF power to the chamber via the RF window 16 to disassociate and ionize the dopant containing molecules in the feed gas and thereby produce a desired ionic specie. The feed gas may be, or may include or contain, in some embodiments, hydrogen, helium, oxygen, nitrogen, arsenic, boron, phosphorus, aluminum, indium, antimony, carborane, alkanes, or other p-type or n-type dopants. The dopant ions thus generated are subsequently extracted from the plasma chamber 12 to form an ion beam that is directed toward a substrate (not shown).

During normal operation of the RF ion source 10, plasma is created in a generally conventional manner through inductive coupling as described above. However, the window shield 18 undergoes heavy ionic bombardment that would otherwise (i.e., in the absence of the window shield 18) be sustained by the RF window 16. As a result of being shielded from such bombardment, the RF window 16 is subjected to significantly less etching relative to conventional ion source configurations and therefore releases fewer impurity atoms into the plasma chamber 12. Fewer impurity ions are therefore produced in the plasma chamber 12 and contributed to the ion beam emitted therefrom. Simultaneously, the ionic bombardment sustained by the window shield 18 frees additional dopant atoms from the shield 18 into the plasma chamber 12. Ionic bombardment is also sustained by the chamber liner 20, albeit at a lower energy than the window shield 18, thereby contributing an additional quantity of dopant atoms to the plasma chamber 12. Dopant ion production within the plasma chamber 12 is thereby increased and a more dopant-rich ion beam is produced. Greater ion density and purity is thus achieved for a given level of RF energy relative to conventional ion sources, thereby reducing the need for beam analyzation and filtering by mass spectrometers and related beam line components.

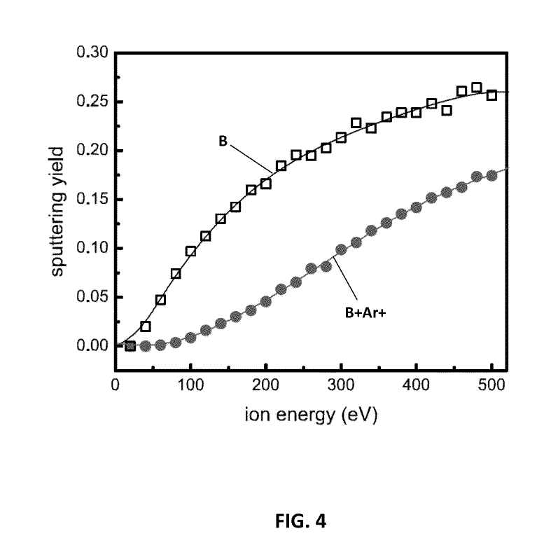

Referring to the experimental results presented FIG. 4, which demonstrate sputtering yield from a window shield formed of boron for boron ions and argon ions (labeled B+ and Ar+, respectively), it can be seen that boron has a sputtering yield of about 0.1 when bombarded with boron ions at about 100 eV. For the low pressures employed in RF plasma sources, and given a relatively high RF driving frequency, a large population of sputtered atomic boron is expected. Given the lack of atomic species having lower ionization potentials (i.e., atomic species other than boron that would be sputtered from an RF window in the absence of the boron window shield) within the plasma chamber, greater boron ion production is therefore expected given a particular input power as described above. Additionally, while the energy of ions striking the boron chamber liner is limited to plasma potential (assuming steady state operation at a temperature where the boron chamber liner is conductive) the sputtering yield of the liner may still be about 0.05 at about 20-40 eV.

Referring again to FIG. 3, a series of slots or apertures 26 may be formed in the window shield 18 for facilitating unobstructed transmission of RF power into the plasma chamber 12 during operation of the RF ion source 10. Particularly, it has been found that as the temperature of some dopant materials increases, such as may occur in the presence of the plasma within the plasma chamber 12, the material may become electrically conductive, which has a detrimental effect on RF power transmission to the working gas in the plasma chamber 12. Boron, for example, exhibits such a characteristic. However, if slots 26 having an orientation perpendicular to the antenna leads are formed in the window shield 18, and the window shield 18 is grounded, the shield 18 will act as a Faraday shield and will allow propagation of the time-varying magnetic field generated by current in the RF antenna 14 while mitigating the dissipation of RF power through eddy currents in the conductive shield 18. While the window shield 18 is shown as having six slots 26 in FIG. 3, it is contemplated that a greater or lesser number of slots 26 may be provided. It is further contemplated that the slots 26 may be entirely omitted from the window shield 18.

In summary, the inventive RF ion source 10 of the present disclosure provides a simple, cost effective means by which a quantity of impurity ions in an ion beam can be minimized without the use of analyzing magnets and other complex, expensive beam line components. Moreover, the RF ion source 10 of the present disclosure simultaneously increases the quantity of desired dopant ions in an ion beam.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. An ion source comprising:
an RF window;
a plasma chamber disposed on a first side of the RF window;
an RF antenna disposed on a second side of the RF window opposite the first side; and
a window shield disposed intermediate the first side of the RF window and the plasma chamber and having at least one aperture formed therethrough, the widow shield configured to sustain ionic bombardment from a plasma within the plasma chamber.

2. The ion source in accordance with claim 1, wherein the plasma chamber is configured to generate the plasma containing species of a feed gas, wherein the window shield is formed of a material composed at least partially of an element contained in the feed gas.

3. The ion source in accordance with claim 2, wherein the element is selected from a group consisting of boron, arsenic, phosphorus, aluminum, indium, and antimony.

4. The ion source in accordance with claim 1, wherein the window shield is substantially planar and is substantially parallel to the RF window.

5. The ion source in accordance with claim 1, wherein the window shield is spaced apart from the RF window a distance in a range of 0 millimeters to 5 millimeters.

6. The ion source in accordance with claim 1, wherein the window shield flatly abuts the RF window.

7. The ion source in accordance with claim 1, wherein the at least one aperture comprises a plurality of slots spaced apart from one another, each slot defined by a portion of the window shield disposed therebetween.

8. The ion source in accordance with claim 7, wherein the slots extend in a direction that is substantially perpendicular to leads of the RF antenna.

9. The ion source in accordance with claim 1, wherein the RF antenna is a flat spiral antenna.

10. The ion source in accordance with claim 1, further comprising a chamber liner disposed adjacent an interior surface of a sidewall of the plasma chamber.

11. The ion source in accordance with claim 10, wherein the plasma chamber is configured to generate the plasma containing species of a feed gas, wherein the chamber liner is formed of a material composed at least partially of an element contained in the feed gas.

12. The ion source in accordance with claim 11, wherein the element is selected from a group consisting of boron, arsenic, phosphorus, aluminum, indium, and antimony.

13. The ion source in accordance with claim 12, wherein the chamber liner is fastened to the sidewall.

14. An ion source comprising:
an RF window;
a plasma chamber disposed on a first side of the RF window;
an RF antenna disposed on a second side of the RF window opposite the first side;
a window shield disposed intermediate the first side of the RF window and the plasma chamber and having at least one aperture formed therethrough; and
a chamber liner disposed adjacent an interior surface of a sidewall of the plasma chamber;
wherein the widow shield and the chamber liner are configured to sustain ionic bombardment from a plasma within the plasma chamber.

15. The ion source in accordance with claim 14, wherein the plasma chamber is configured to generate the plasma containing species of a feed gas, wherein the window shield and the chamber liner are formed of a material composed at least partially of an element contained in the feed gas.

16. The ion source in accordance with claim 15, wherein the element is selected from a group consisting of boron, arsenic, phosphorus, aluminum, indium, and antimony.

17. The ion source in accordance with claim 14, wherein the at least one aperture comprises a plurality of slots spaced apart from one another, each slot defined by a portion of the window shield disposed therebetween.

18. The ion source in accordance with claim 17, wherein the slots extend in a direction that is substantially perpendicular to leads of the RF antenna.
